(19) United States
(12) Patent Application Publication
(10) Pub. No.: US 2011/0064165 A1
(43) Pub. Date: Mar. 17, 2011

(54) DEMODULATION APPARATUS AND METHOD FOR RFID READER IN PASSIVE RFID ENVIRONMENT

(75) Inventors: Ji-Hoon BAE, Daejeon (KR); Donghan LEE, Daejeon (KR); Kwang-Soo CHO, Daejeon (KR); Man Sik PARK, Daejeon (KR); Chan-Won PARK, Daejeon (KR); Cheng-Hao QUAN, Daejeon (KR); Won Kyu CHOI, Daejeon (KR); Gil Young CHOI, Daejeon (KR); Jong-Suk CHAE, Daejeon (KR)

(73) Assignee: Electronics and Telecommunications Research Institute, Daejeon (KR)

(21) Appl. No.: 12/625,699

(22) Filed: Nov. 25, 2009

(30) Foreign Application Priority Data
Sep. 11, 2009 (KR) 10-2009-0086062

(51) Int. Cl. H04L 27/22; H04L 25/06; H04L 27/00; H04Q 5/22

(52) U.S. Cl. 375/319; 375/324; 375/329; 340/10.1

(57) ABSTRACT

A demodulation apparatus for a Radio Frequency Identification (RFID) reader includes: a direct current (DC) offset cancellation unit for cancelling DC-offset noise contained in a PSK-modulated or ASK-modulated subcarrier tag signal from the tag signal when the tag signal is received; and a subcarrier digital demodulator for eliminating a subcarrier from the tag signal from which DC-offset noise has been cancelled to demodulate the DC-offset noise-cancelled tag signal.

### CROSS-REFERENCE(S) TO RELATED APPLICATION(S)

The present invention claims priority of Korean Patent Application No. 10-2009-0086062, filed on Sep. 11, 2009, which is incorporated herein by reference.

### FIELD OF THE INVENTION

The present invention relates to a demodulation apparatus for a Radio Frequency Identification (RFID) reader, and, more particularly, to a demodulation apparatus and method for an RFID reader in passive RFID environment, which can effectively cancel DC-offset noise from tag signals distorted by the DC-offset noise, and can more precisely perform sub-carrier digital demodulation.

### BACKGROUND OF THE INVENTION

Typically, RFID technology is used for recognizing, tracking and managing objects, animals and persons to which tags having unique identification information are attached, by reading or writing information from or to the tags in a non-contact manner using a radio frequency. That is, RFID technology refers to a technology for identifying information from a remote place using electric waves. In order to implement such an RFID technology, RFID tags and an RFID reader are required. The RFID tags are each composed of an Integrated Circuit (IC) for recording information therein and an antenna for transmitting information to the reader. Such information is used to identify objects having tags attached thereon.

An RFID system using the RFID technology performs a function similar to that of a barcode. However, unlike the barcode system, the RFID system reads information using electric waves instead of a light. Therefore, the RFID system can read tag information even at a long distance, while a barcode reader operates only at a short distance. Further, the RFID system can receive tag information even through an obstacle placed in front of a target.

As described above, the RFID system includes a plurality of tags (electronic tags or transponders), each provided with unique identification information and attached to an object, animal or the like, and an RFID reader (or an interrogator) for reading or writing the information from or to the tags.

Such RFID systems may be classified into an inductively coupled method and a method using electromagnetic wave according to a communication method between a reader and tags, and classified into an active type and a passive type according to whether a tag operates using its own power.

Here, a passive RFID system uses only a reader's own power to read tag information and perform communication, while an active RFID system uses power of a tag to perform the same.

Further, there is a semi-passive RFID system, which has a battery embedded in a tag. The semi-passive RFID system operates in a manner that it uses power of the embedded battery only to read tag information but uses power of a reader for communication.

Meanwhile, RFID systems may also be classified into long wave, medium wave, short wave, ultrashort wave and microwave types depending on the frequency of electric waves used for communication. An RFID system using a low frequency is called a Low-Frequency Identification (LFID) system, in which electric waves of 120140 KHz are used. A High-Frequency Identification (HFID) system uses electric waves of 13.56 MHz. An Ultra-High-Frequency Identification (UHFID) system exploits electric waves of 868˜956 MHz which is higher than those of the HFID system.

The RFID technology has widely been applied to various fields. For example, the RFID technology is used for measuring records of athletes or tracking production history of goods, and even for passports and ID cards by attaching tags storing personal information to the passports and ID cards.

In addition, the RFID technology is also used for traffic cards and a toll collection system, and additionally also used to protect wild animals or manage domestic animals by inserting tags under the skin of the animals.

Furthermore, RFID tags may be occasionally inserted into human bodies. In the future, fields to which RFID is applicable will be further extended. In particular, RFID has attracted attention as a substitute for a barcode. This is because an RFID tag uses an IC as a memory, so that various types of information can be recorded, compared to the barcode in which information is written by a simple black and white pattern, thus greatly expanding the usability of RFID.

Therefore, the RFID system can assign serial numbers to individual products, persons or objects, which may be a very useful function for managing stocks and preventing objects from being stolen.

Recently, in addition to the above-described fields in which RFID is used, application fields of RFID are gradually extending from pallet- or box-based identification of objects to the individual unit-based identification of objects. Currently, the international standardization of ISO 18000-3 Part 3 (HF Gen2) is being carried out to apply the high-performance Gen2 protocol standard in an Ultra High Frequency (UHF) band to a High Frequency (HF) band profitable for metal and liquid environments. In the HF Gen2 standard, the methods of a subcarrier which is transmitted from a tag to a reader are presented by two methods, i.e., a Manchester subcarrier and a Miller subcarrier.

A Manchester subcarrier signal has a format in which four pulse cycles are present in a half period of a symbol, as shown in FIG. 1, and DC components exist in a frequency domain. An RFID reader communicating with RFID tags through magnetic coupling in an HF band performs transmission and reception using a single antenna. Accordingly, when such a reader communicates with tags at high output power, DC-offset noise may occur in a receiver of the reader. When tag signals are distorted by the DC-offset noise, demodulation performance of the reader may be degraded.

FIG. 2 shows a time-signal level graph illustrating a Manchester subcarrier tag signal, and FIG. 3 shows a time-signal level graph illustrating a Manchester subcarrier tag signal distorted by offset noise.

As shown in FIG. 3, a transmission energy component leaked to a receiver of an RFID reader may cause DC-offset noise.

When a subcarrier signal having a DC component in a frequency domain, such as a Manchester subcarrier signal, is distorted by the DC-offset noise, demodulation performance of the receiver of the RFID reader is degraded. Accordingly, a problem arises in that it is impossible to extract valid tag information from tag signals received through a receiver of an RFID reader.

### SUMMARY OF THE INVENTION

In view of the above, the present invention provides a demodulation apparatus and method for an RFID reader in passive RFID environment, which can more precisely restore tag signals using a subcarrier digital demodulation scheme while efficiently cancelling DC-offset noise from distorted tag signals, even if the tag signals are distorted by the DC-offset noise or the like being present in the tag signals received through an antenna of the reader.

In accordance with a first aspect of the present invention, there is provided a demodulation apparatus for a Radio Frequency Identification (RFID) reader, including:

a direct current (DC) offset cancellation unit for cancelling DC-offset noise contained in a PSK-modulated or ASK-modulated subcarrier tag signal from the tag signal when the tag signal is received; and

a subcarrier digital demodulator for eliminating a subcarrier from the tag signal in which DC-offset noise has been cancelled to demodulate the tag signal.

In accordance with a second aspect of the present invention, there is provided a demodulation method for a Radio Frequency Identification (RFID) reader, including:

cancelling direct current (DC)-offset noise contained in a PSK-modulated or ASK-modulated subcarrier tag signal, from the tag signal, when the tag signal is received; and

demodulating the DC-offset noise-cancelled tag signal by eliminating a subcarrier from the DC-offset noise-cancelled tag signal.

### BRIEF DESCRIPTION OF THE DRAWINGS

The above features of the present invention will become apparent from the following description of preferred embodiments given in conjunction with the accompanying drawings, in which:

FIG. 1 is a graph illustrating the format of Manchester subcarrier symbol signals;

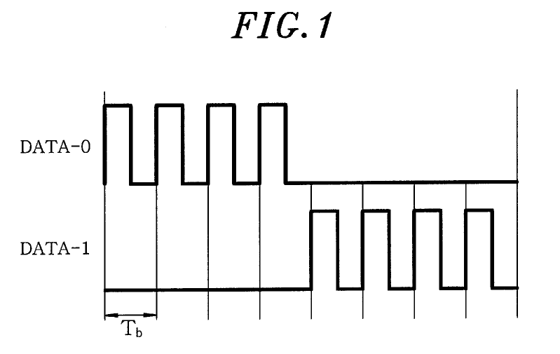

FIG. 2 is a time-signal level graph illustrating a Manchester subcarrier tag signal stream composed of symbol 1 and symbol 0;

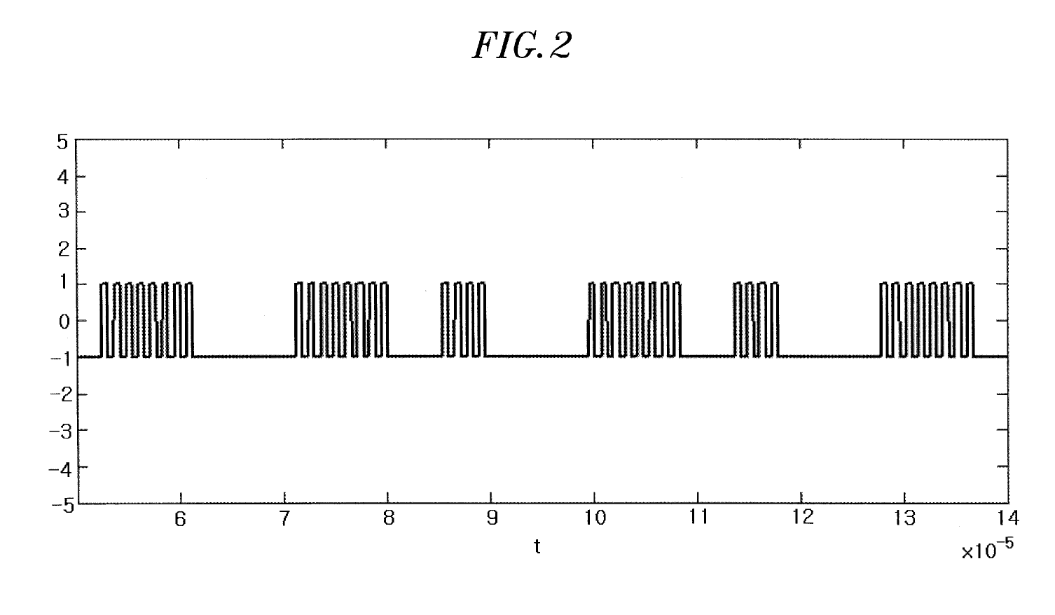

FIG. 3 is a time-signal level graph illustrating a Manchester subcarrier tag signal distorted by DC-offset noise;

FIG. 4 is a block diagram showing a demodulation apparatus for an RFID reader, having a subcarrier digital demodulation scheme, in accordance with an embodiment of the present invention;

FIG. 5 is a block diagram showing a matched filter for canceling DC-offset noise contained in a tag signal in accordance with the embodiment of the present invention;

FIG. 6 is a time-signal level graph illustrating a tag signal from which DC-offset noise has been cancelled in accordance with the embodiment of the present invention;

FIG. 7 is a time-signal level graph illustrating a tag signal obtained by canceling low noise contained in the tag signal of FIG. 6 in accordance with the embodiment of the present invention;

FIG. 8 is a time-signal level graph illustrating a baseband signal generated through the elimination of a subcarrier in accordance with the embodiment of the present invention; and

FIG. 9 is a graph illustrating a TTL-level signal obtained when the baseband signal of FIG. 8 passes through a limiter in accordance with the embodiment of the present invention.

### DETAILED DESCRIPTION OF THE EMBODIMENTS

Hereinafter, operating principles of the present invention will be described in detail with reference to the accompanying drawings. In the description of the present invention, if detailed descriptions of related well-known constructions or functions are determined to make the gist of the present invention unclear, the detailed descriptions will be omitted. The following terms are terms that are defined while considering their functions in the present invention. Since the meanings of the terms may vary according to a user's or an operator's intention or usual practice, the meanings of the terms must be interpreted based on the overall context of the present specification.

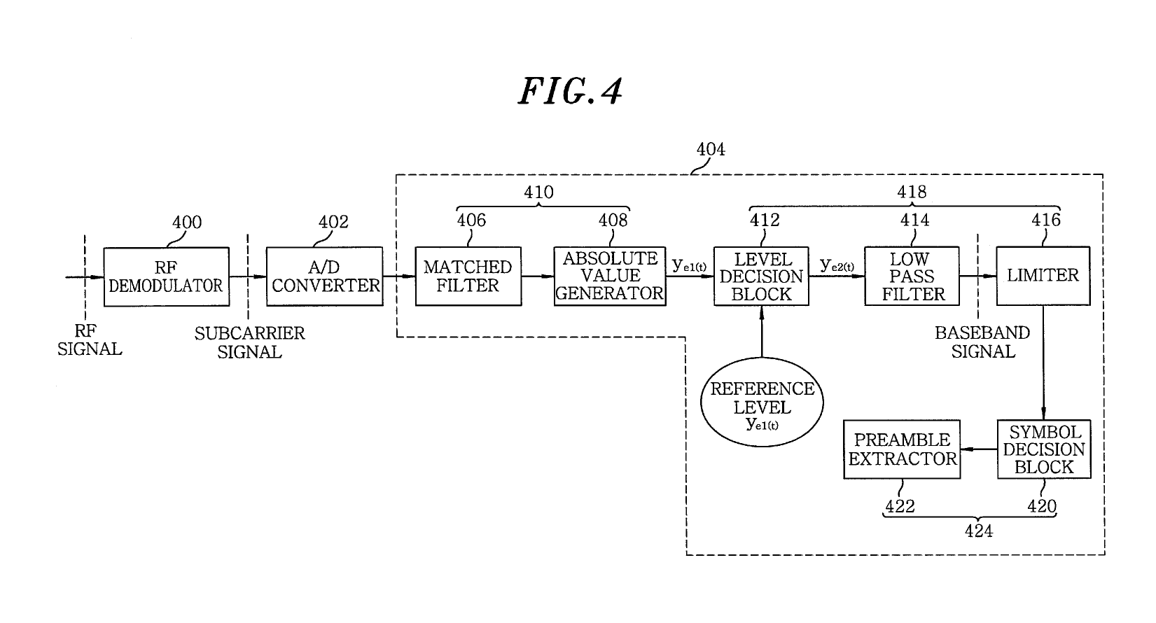

FIG. 4 is a block diagram showing a configuration of a receiver of RFID reader having a subcarrier digital demodulation scheme. The receiver of RFID reader includes a Radio Frequency (RF) demodulator 400 and an analog/digital (A/D) converter 402, and a demodulation apparatus 404 for an RFID reader.

Referring to FIG. 4, the RF demodulator 400 cancels a carrier signal included in a tag signal received by the receiver of RFID reader. The A/D converter 402 converts an analog signal outputted from the RF demodulator 400 into a digital signal. The demodulation apparatus 404 for an RFID reader in accordance with an embodiment of the present invention has an interface with an A/D converter 402, and includes a DC offset cancellation unit 410, a subcarrier digital demodulator 418, and a decoding block 424.

The DC offset cancellation unit 410 cancels DC-offset noise, contained in a tag signal input from the A/D converter 402, from the tag signal in a feed-forward manner and includes a matched filter 406 and an absolute value generator 408.

The matched filter 406 is used to reduce the influence of noise added during transmission of signals, in a receiver of a digital communication system. The matched filter 406 is implemented such that parameters of the filter match characteristics of a previously known input tag signal, and the maximum output value is obtained when the input tag signal is received.

In digital communication, the waveform or amplitude of a pulse is not particularly important, and the precise determination of whether a pulse is present or not is important. Accordingly, the matched filter 406 maximally emphasizes the component of an input signal at the moment at which the presence of a pulse is determined during a period of a pulse width.

In addition, the matched filter 406 minimizes an error rate by determining the presence of a pulse through the suppression of a noise component.

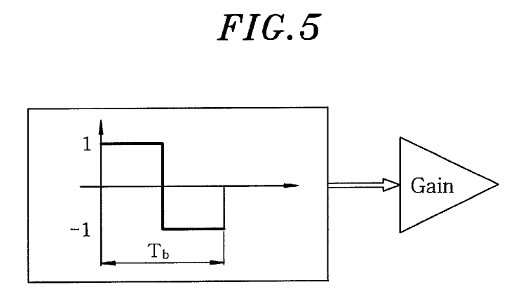

A diagram of the matched filter 406 is shown in FIG. 5. Referring to FIG. 5, the matched filter 406 includes a filter having a square-pulse shape identical to that of a subcarrier and a gain block, thus effectively canceling DC-offset noise contained in a tag signal even if the tag signal fluctuates due to the DC-offset noise.

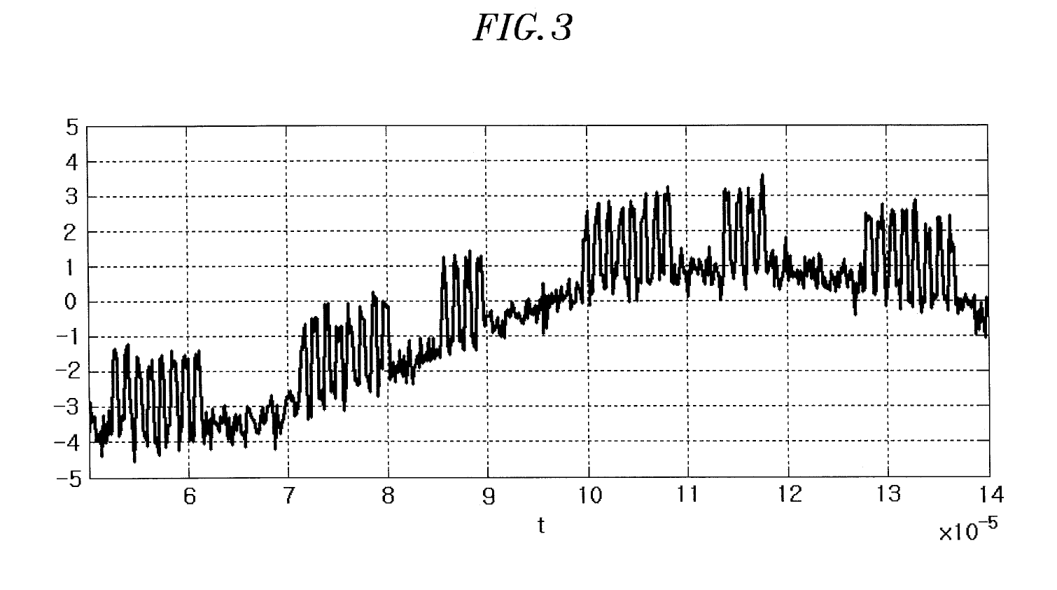

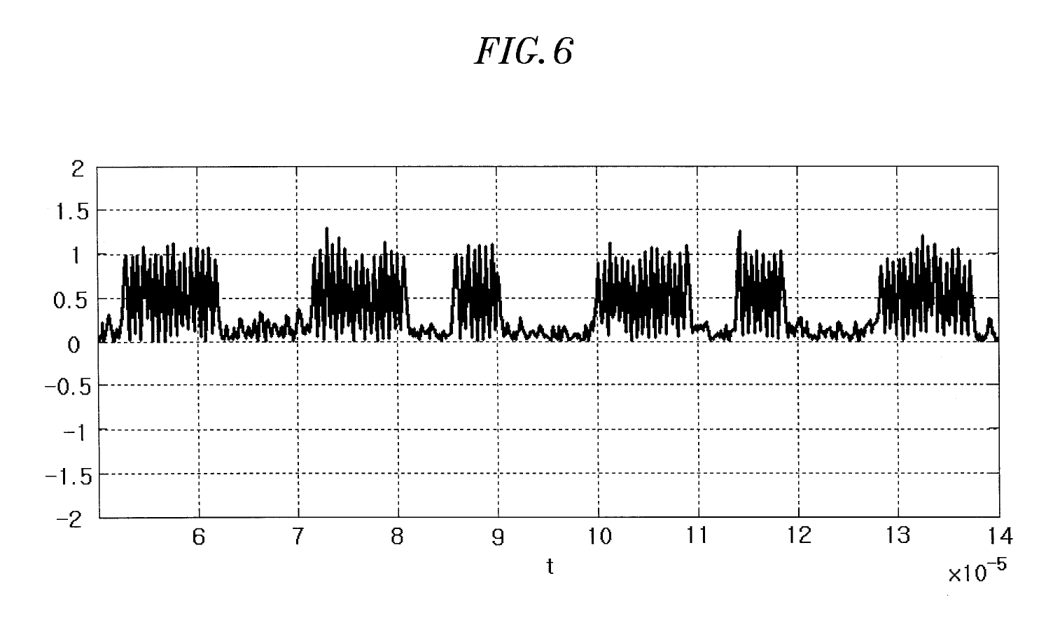

FIG. 6 is a graph illustrating the results obtained when the Manchester subcarrier tag signal of FIG. 3, which is distorted by DC-offset noise, passes through the DC offset cancellation unit 410 of FIG. 4.

Referring to FIG. 4, a level decision block 412 in the subcarrier digital demodulator 418 is used for determining the level of the received tag signal. The level decision block 412 sets in advance a reference level y_{ref} of a tag signal desired to be received and allows only signals having levels equal to or greater than the preset reference level y_{ref}, among received tag signals, to pass through the level decision block 412.

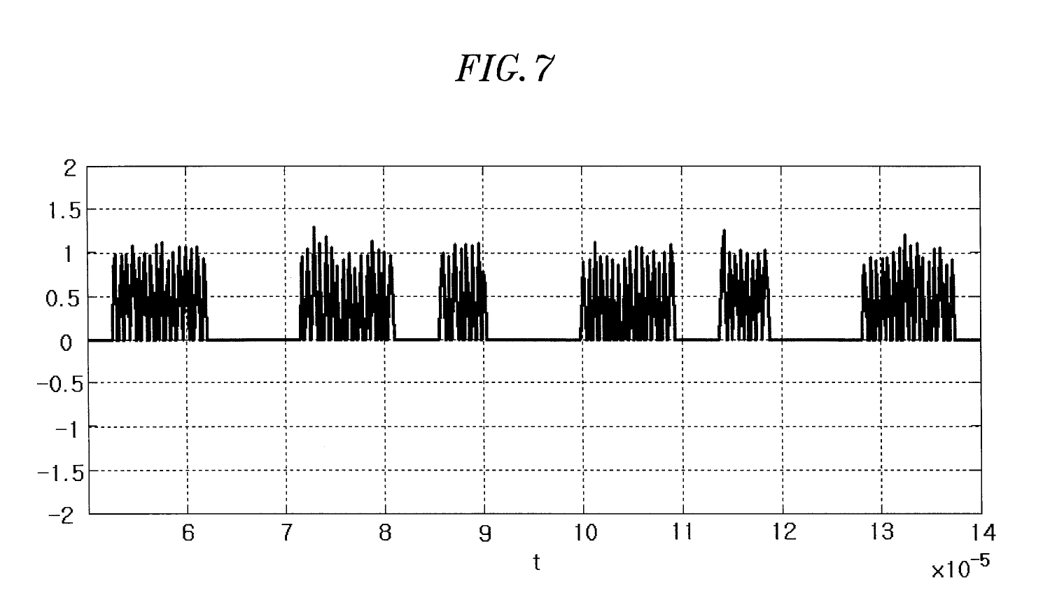

Accordingly, when the tag signal from which DC offset noise has been cancelled, same as shown in FIG. 6, passes through the level decision block 412, all of low noises of a level less than the reference level y_{ref}, which is contained in a tag signal yₑ₁(t), is cancelled, and thus a low noise-cancelled tag signal yₑ₂(t) is generated in the level decision block 412, as shown in FIG. 7.

The low noise-cancelled tag signal yₑ₂(t) is represented as in the following Equation (1).

$${y}_{e 2} ( t ) = \{ \begin{matrix}{y}_{e 1} ( t ) , & {y}_{e 1} \geq {y}_{ref} \\ 0 , & {y}_{e 1} 〈 {y}_{ref}\end{matrix} \qquad Equation ( 1 )$$

Next, as described above, the tag signal, from which the low noise has been cancelled by the level decision block 412, is input to a low pass filter 414. The low pass filter 414 eliminates a subcarrier from the low noise-cancelled tag signal outputted from the level decision block 412 and generates a baseband signal.

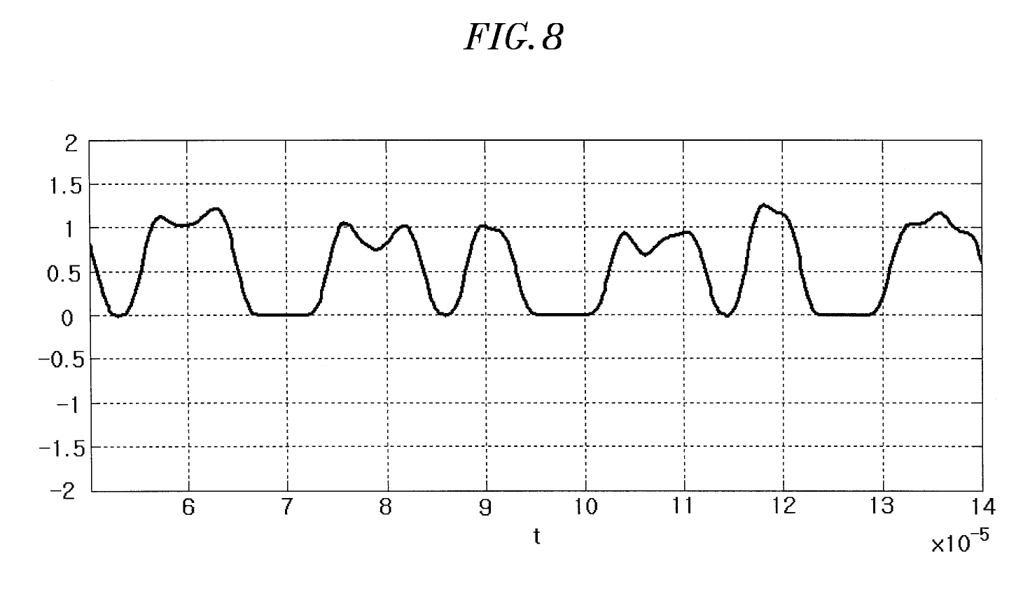

FIG. 8 is a time-signal level graph illustrating a baseband signal generated as a result of operation of the subcarrier digital demodulator 418 eliminating a subcarrier from a tag signal in accordance with the embodiment of the present invention.

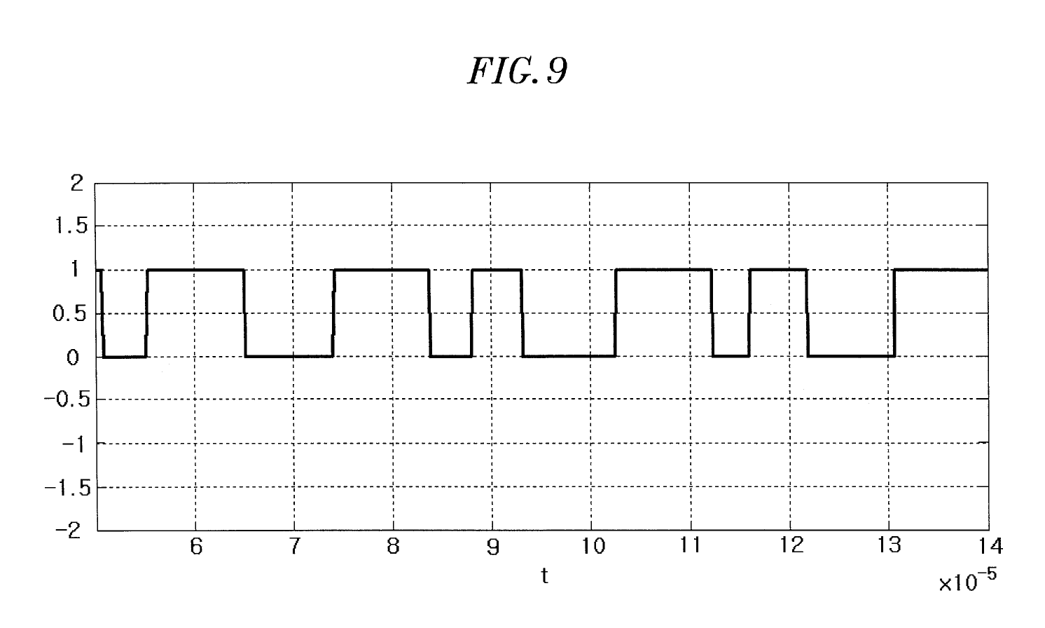

The baseband signal, generated by eliminating the subcarrier from the tag signal using the low pass filter 414, is input to the limiter 416. The limiter 416 limits the amplitude of the baseband signal on the basis of a predetermined constant voltage level to generate a tag signal of TTL (Transistor-Transistor Logic)-level. FIG. 9 shows a graph of the TTL-level tag signal generated by the limiter 416 from the baseband signal that has been generated by the elimination of the subcarrier. The TTL-level tag signal whose amplitude has been limited by the limiter 416 on the basis of the constant voltage level, is decoded by a decoding unit 424 to extract tag information contained in the tag signal.

The operation of the decoding unit 424 will be described in detail below. The decoding unit 424 includes a symbol decision block 420 and a preamble extractor 422.

The symbol decision block 420 restores a data pulse from the tag signal inputted from the limiter 416, and determines symbol data on the basis of a pulse width of the restored data pulse.

The preamble extractor 422 detects a preamble from the tag signal by combining patterns of segments of symbol data outputted from the symbol decision block 420 and determining whether the combination of the patterns is identical to a preamble defined in standards, and thereafter extracts tag information using the detected preamble.

That is, the preamble, containing the start information of tag data, is detected from the symbol data, and the tag information is extracted and outputted based on the preamble.

As described above, the present invention cancels DC-offset noise from a tag signal distorted by the DC-offset noise that may occur due to a transmission energy component leaked to a receiver of an RFID reader, using a matched filter which matches signal characteristics of the tag signal and an absolute value generator. Further, the present invention eliminates a subcarrier, using a subcarrier digital demodulator including a level decision block, a low pass filter and a limiter, from the tag signal whose DC-offset noise has been cancelled and decodes the tag signal, thereby extracting tag information.

Therefore, according to the present invention, when a subcarrier signal having a DC frequency component is received in passive RFID environment where DC-offset noise exists, the DC-offset noise can be effectively cancelled from the subcarrier signal, and tag information can be more precisely detected using a subcarrier digital demodulation scheme.

While the invention has been shown and described with respect to the embodiments, it will be understood by those skilled in the art that various changes and modification may be made without departing from the scope of the invention as defined in the following claims.

What is claimed is:

1. A demodulation apparatus for a Radio Frequency Identification (RFID) reader, comprising:
a direct current (DC) offset cancellation unit for cancelling DC-offset noise contained in a PSK-modulated or ASK-modulated subcarrier tag signal from the tag signal when the tag signal is received; and
a subcarrier digital demodulator for eliminating a subcarrier from the tag signal from which DC-offset noise has been cancelled to demodulate the DC-offset noise-cancelled tag signal.

2. The demodulation apparatus of claim 1, wherein the DC offset cancellation unit includes:
a matched filter for reducing influence of noise added during transmission of the tag signal; and
an absolute value generator for generating an absolute value of the signal outputted from the matched filter.

3. The demodulation apparatus of claim 2, wherein the matched filter matches characteristics of the tag signal, and thus generates a maximum output value while suppressing a noise component contained in the tag signal.

4. The demodulation apparatus of claim 3, wherein the matched filter has a square pulse identical to that of the subcarrier.

5. The demodulation apparatus of claim 1, wherein the subcarrier digital demodulator includes:
a level decision block for cancelling low noise contained in the DC-offset noise-cancelled tag signal outputted from the DC offset cancellation unit based on a predetermined reference level;
a low pass filter for eliminating the subcarrier from the low noise-cancelled tag signal outputted from the level decision block, thus generating a baseband signal; and
a limiter for limiting an amplitude of the baseband signal generated by the low pass filter, on the basis of a predetermined voltage level.

6. The demodulation apparatus of claim 5, wherein the level decision block generates the low noise-cancelled tag signal by canceling low noise having a level less than the predetermined reference level, which is contained in the DC-offset noise-cancelled tag signal, using the following equation:
$${y}_{e 2} ( t ) = \{ \begin{matrix}{y}_{e 1} ( t ) , & {y}_{e 1} \geq {y}_{ref} \\ 0 , & {y}_{e 1} 〈 {y}_{ref}\end{matrix}$$
where yₑ₂(t) is the low noise-cancelled tag signal, yₑ₁(t) is the DC-offset noise-cancelled tag signal, and y_{ref} is the predetermined reference level.

7. The demodulation apparatus of claim 5, wherein the low pass filter eliminates the subcarrier contained in the low noise-cancelled tag signal by filtering the low noise-cancelled tag signal through a predetermined low frequency band.

8. The demodulation apparatus of claim 1, wherein the tag signal includes information on an object to which an RFID tag is attached.

9. The demodulation apparatus of claim 1, further comprising a decoding unit for decoding the tag signal demodulated by the subcarrier digital demodulator, thus extracting tag information from the demodulated tag signal.

10. The demodulation apparatus of claim 9, wherein the decoding unit includes:
a symbol decision block for restoring a data pulse from the demodulated tag signal and determining symbol data based on a pulse width of the data pulse; and
a preamble extractor for combining patterns of the symbol data to detect a preamble from the demodulated tag signal and extracting the tag information using the detected preamble.

11. A demodulation method for a Radio Frequency Identification (RFID) reader, comprising:
cancelling direct current (DC)-offset noise contained in a PSK-modulated or ASK-modulated subcarrier tag signal, from the tag signal, when the tag signal is received; and
demodulating the DC-offset noise-cancelled tag signal by eliminating a subcarrier from the DC-offset noise-cancelled tag signal.

12. The demodulation method of claim 11, wherein said cancelling DC-offset noise includes:
reducing influence of noise added during transmission of the tag signal; and
generating an absolute value of the signal in which influence of the noise has been reduced.

13. The demodulation method of claim 12, wherein said reducing influence of the noise includes matching characteristics of the tag signal to generate a maximum output value while suppressing a noise component contained in the tag signal.

14. The demodulation method of claim 12, wherein the matched filter has a square pulse identical to that of the subcarrier.

15. The demodulation method of claim 11, wherein said demodulating the DC-offset noise-cancelled tag signal includes:
cancelling low noise contained in the DC-offset noise-cancelled tag signal, on the basis of a predetermined reference level;
eliminating the subcarrier from the low noise-cancelled tag signal, thus generating a baseband signal; and
limiting an amplitude of the baseband signal based on a predetermined voltage level.

16. The demodulation method of claim 15, wherein the low noise-cancelled tag signal is generated by cancelling low noise having a level less than the predetermined reference level, which is contained in the DC-offset noise-cancelled tag signal, using the following equation:
$${y}_{e 2} ( t ) = \{ \begin{matrix}{y}_{e 1} ( t ) , & {y}_{e 1} \geq {y}_{ref} \\ 0 , & {y}_{e 1} 〈 {y}_{ref}\end{matrix}$$
where yₑ₂(t) is the low noise-cancelled tag signal, yₑ₁(t) is the DC-offset noise-cancelled tag signal, and y_{ref} is the predetermined reference level.

17. The demodulation method of claim 15, wherein the subcarrier contained in the low noise-cancelled tag signal is eliminated by filtering the low noise-cancelled tag signal through a predetermined low frequency band.

18. The demodulation method of claim 11, wherein the tag signal includes information on an object to which an RFID tag is attached.

19. The demodulation method of claim 11, further comprising, after said demodulating the DC-offset noise-cancelled tag signal, decoding the demodulated tag signal, thus extracting tag information from the demodulated tag signal.

20. The demodulation method of claim 19, wherein said decoding the demodulated tag signal includes:
restoring a data pulse from the demodulated tag signal and determining symbol data based on a pulse width of the data pulse; and
combining patterns of the symbol data to detect a preamble from the demodulated tag signal and extracting the tag information using the detected preamble.
